(19) United States
(12) Patent Application Publication
(10) Pub. No.: US 2003/0149745 A1
(43) Pub. Date: Aug. 7, 2003

(54) Method and apparatus for accessing information from a network data source

(76) Inventors: Reszo Dunay, Budapest (HU); Sandor Fejes, Szeged (HU); Peter Harmat, Budapest (HU); Attila Medl, Mosonmagyarovar (HU); Gyula Roman, Budapest (HU)

Correspondence Address: PATENT DOCKET DEPARTMENT, GARDNER CARTON & DOUGLAS LLC, 191 N. WACKER DRIVE, SUITE 3700, CHICAGO, IL, 60606, US

(21) Appl. No.: 10/311,502

(22) PCT Filed: Jun. 28, 2001
(86) PCT No.: PCT/HU01/00072

(30) Foreign Application Priority Data
Jun. 28, 2000 (HU) P0002471

(51) Int. Cl. G06F 15/16

(52) U.S. Cl. 709/217

(57) ABSTRACT

The invention concerns a method for accessing information from a network data source, where the network data source is managed by a server means. In the method an information request is sent through the network to the server means from a requesting telecommunication means, and information is retrieved from the data source with the server means. The information retrieved from the data source is forwarded to a receiving telecommunication means, and further the information used at the receiving telecommunication means is transformed. According to the invention, dynamically determined unique transformation data is associated to the information request, where the transformation data is determined based upon a predetermined and/or previously fixed parameter system. The requested information is transformed based on the unique transformation data, and the information transformed according to the unique transformation data is used at the receiving telecommunication means. The invention also concerns the system, server means and receiving means for implementing the method.

### TECHNICAL FIELD

The object of the present invention is a method for accessing information from a network data source, the network data source being managed by a server means. According to the inventive method, an information request is sent through the network to the severs means, then information is retrieved from the data source with the server means, and the information retrieved from the data source is forwarded to a receiving telecommunication means. Information used at the receiving telecommunication means is transformed. The object of the invention is a system for performing the steps of the method, and a computer program product comprising commands to execute the steps of the method and further comprising commands to operate the system and/or parts of the system.

### BACKGROUND ART

A major problem of today's information technology is to quickly select information relevant to a particular user from the huge bulk of information that can be accessed via the Internet, thereby avoiding unnecessary information requests. There is no known generally applicable solution to this problem. Existing solutions all solve only fractions of the problem. For instance, there are certain websites, particularly the so-called “portals” that in principle offer customized information to users visiting the website regularly. In reality, however, customization amounts merely to providing the possibility for the user to choose the entry address of his own page and to select menu items and other entry points that he would like to access more easily, with fewer mouse clicks. In this manner, information may be filtered only according to such criteria which was provided beforehand by the information provider, e. g. by classifying the provided content into certain categories. It is not possible for the user to perform the filtering according to his own filtering criteria, and to perform this filtering only on certain selected information sources.

Using a search engine and performing research on electronic sources are existing examples of customized information filtering performed on multiple documents at the same time. However, in these cases the filtering is performed on multiple documents simultaneously, and on documents which are not known to the user. Therefore, it is not possible to receive the particular documents individually filtered. Particularly, no method is known in which individual documents are forwarded to the user after having been individually edited.

There is no known solution for the task of retrieving information, e.g. a web page with individual content filtering, formatting, editing and supplementing, i. e. where the filtering, formatting, editing and supplementing is performed with criteria relating to that specific web page only.

It is an object of the invention to provide at least a partial solution to the problem mentioned above.

### SUMMARY OF THE INVENTION

According to the present invention our aim is achieved by the method described above, during which

dynamically determined unique transformation data are associated to the information request, the transformation data being determined based on a predetermined and/or previously fixed parameter system,

and the requested information is transformed based on the unique transformation data.

Finally, the information transformed according to the unique transformation data is used at the receiving communication means.

According to the method, information is requested through a so-called requesting communications channel. The user launches the information request towards the system through this channel, but in a number of cases the channel is used to transmit to the system input data entered by the user (e.g. selected words, numeric values, characters) or data identifying the user (e.g. location information, phone numbers).

Preferably, we can regard as unique transformation data unique data that are

associated to the person receiving the information

and/or associated to the parameters of the requesting and/or receiving communication means

and/or extracted from the contents of the requested information

and/or related to the data structure of the data source.

In the majority of cases, personal data of the receiving person or data relating to the receiving person are regarded as the unique data associated to the person receiving the information, where the data relating to the receiving person are previously determined by the receiving person or by any other person. Using the requesting channel usually provides sufficient data in itself for describing the user because of the characteristics of the protocol of said requesting channel.

In an advantageous implementation, the unique transformation data are determined with a configuring telecommunication means. Optionally, a configuring communications channel can be assigned to the configuring telecommunication means.

According to the method, a separate data source communications channel can be included to connect the data source and the server means. The data source communications channel is a channel through which the information arrives when requested by the user. This channel may also transmit previously stored data and input data (if any) to the ultimate source of information, the data source, in order to perform a request or, optionally, to perform a two-way data exchange transaction. The source document is transmitted to the server means through the source communications channel.

The main application area of inventive method is the accessing of information (documents) that can be requested from the Internet, from a standalone computer, from a server computer, from a computer network, or can be accessed using other communications or telecommunications channels. Such information (document) can be a WAP page (Wireless Application Protocol),, a WEB page, an XML document (eXtensible Markup Language), where documents are retrieved either by FTP (File Transfer Protocol), telnet, NFS (Network File System), or from a database or local file.

The method can also be applied for retrieving information that can be accessed via SMS messages (Short Message Service), telephone calls or by means of a human or machine (synthesised human) voice-driven information service. The retrieved information can be an ActiveX, Java, or JavaScript application or applet, or alternatively the method can be embedded in such applications or applets.

The method can be applied in electronic commerce, when access of information is performed typically during a transaction for concluding an agreement, where the agreement is based on data exchange.

The inventive method can be performed in such a way that at least a part of the transformation data is included in the information request. It is useful, however, to store at least a part of the transformation data in a separate database. In that case the information request contains data for connecting to the database.

According to the method, data determining the filtering and/or editing and/or supplementing and/or displaying of the information are usually regarded as transformation data. The change of the information with respect to its previous state is also frequently regarded as transformation data. Furthermore, we can regard data for determining the unification of the information with other pieces of information as transformation data, or, in other cases, data for the identification of the requesting person can also be considered as transformation data.

According to another aspect of the inventive method, authentication data can be forwarded to the server means and/or to the data source in connection with the information request, especially in case the data source can only be accessed after a user authentication procedure involving a password or a similar identifier.

The transformation of the information according to the transformation data is performed at least partly with the server means and/or with the receiving telecommunication means. Alternatively, the transformation of the information according to the transformation data can also be performed at least partly with a transformation means in the receiving communications channel between the server means and the receiving telecommunication means.

The inventive method is usually applied for accessing information via the Internet. Accordingly, a computer and/or cable phone and/or mobile phone and/or PDA device (e.g. signalling with a pager, or other Portal Device Application) may be used as requesting and/or receiving and/or configuring means.

A further object of the invention is a system performing the steps of the inventive method, providing for accessing information from a network data source, where the network data source is managed by a server means. The system according to the invention comprises a data source and a server means connected to the data source, and further comprises a receiving means and a receiving communications channel and/or requesting communications channel for facilitating data traffic with the server means. In the inventive system the server means and the receiving means is programmed to perform in cooperation with each other the steps of the method according to the invention,

They system preferably comprises a separate data source communications channel between the server means and the data source, together with a data storage means storing transformation data, the data storage means being connected to the server means.

The server means may comprise a single server or multiple interconnected servers, where the server means usually comprises a data source server and/or WAP server and/or WEB server and/or database server and/or DFT database server.

The inventive method can be used primarily for accessing databases via the Internet, where the method is implemented using Internet-based communications channels with their well-known protocols. All communications procedures and information carrier media known in the practice of using the Internet can therefore be exploited to perform steps of the method, e.g. use of static and dynamic VVEB pages, XML documents, WAP pages, running Java or JavaScript applications, sending e-mails, etc. According to the method, the data needed for retrieving the desired information can be communicated via a mobile phone, via a cable phone line, or using speech recognition and/or a fax machine. The method is especially suitable for mobile applications such as sending SMS messages or using WAP pages. Similarly, the method can be used with communications protocols based on ISDN (Integrated Services Digital Network) connections and modems, and also with conventional data exchange channels of computer networks such as TCP/IP (Transmission Control Protocol/Internet Protocol), ftp, telnet, NFS, and file send and receive. When designing implementations of the inventive method, the existing network communications routines of particular applications running on desktop, palmtop and notebook computers, as well as of existing user interfaces of particular programs, e.g. of Excel. may be used advantagously.

A further object of the invention is a computer program product comprising commands to execute the server-side steps and the user means-side steps of the inventive method.

### BRIEF DESCRIPTION OF DRAWINGS

Details of the invention are exemplified by the attached drawings, where

FIG. 1 depicts the structure of transformation data applied in the method according to the present invention,

FIG. 2 shows the basic structure of the filter template file,

FIG. 3 shows the principle of storing filter template files applied in the method,

FIG. 4 depicts the process of creating transformation data applied in the method,

FIG. 5 shows the application of transformation data in the course of the method described,

FIG. 6 shows the principal structure of the system performing steps of the method according to the present invention, and

FIG. 7 depicts a modified version of the system shown in FIG. 6, and

FIG. 8 illustrates the hardware devices implementing the method.

### BEST MODE FOR CARRYING OUT THE INVENTION

Referring to FIGS. 1-5, and FIGS. 6,7 and 8, steps of the method according to the present invention are illustrated by the description of the process of accessing a common web page.

In the course of the method herein described, information is requested from a web page 12 marked by a bookmark 10 by means of a telecommunications network 43, in this case through a direct Internet connection. The web page 12 can be regarded as information retrieved from a data source 16 being managed by a server means 14. Requesting information is performed by first sending an information request through the network 43 from a requesting telecommunication means 18 to the sever means 14. Information is then retrieved by the server means 14 from the data source 16, for example from a web page 12. Information retrieved from the data source 16 is forwarded to a receiving telecommunication means 20. As an essential step of the method, the information used by the receiving telecommunication means 20, e.g. a computer, is transformed. The present invention relates to the way that this transformation takes place.

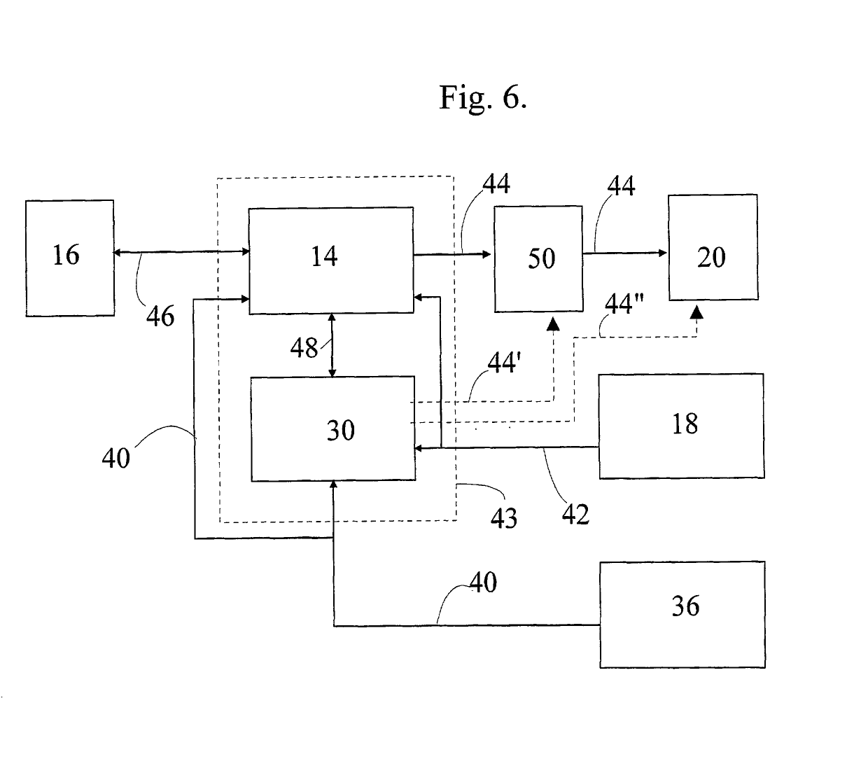

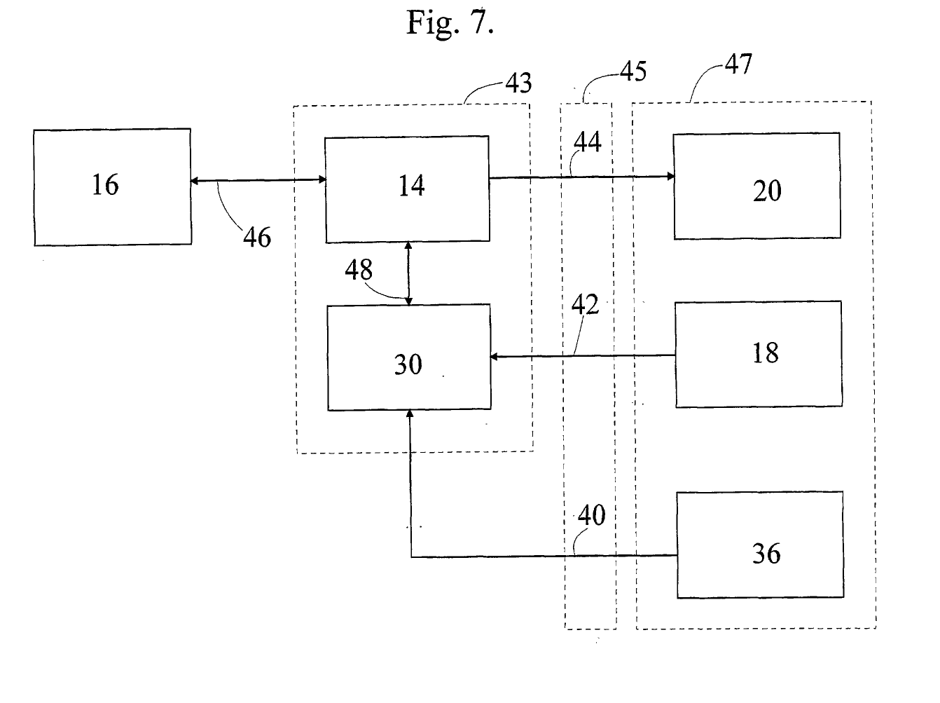

In FIGS. 6 and 7 only the server means 14 and the user profile database 30 are shown as parts of the network 43. In reality, however, the network 43 may comprise the data source 16 itself, as well as the receiving telecommunication means 20 and the requesting telecommunication 18, or even the configuring telecommunication means 36 (see below).

According to the invention, unique transformation data determined previously and/or specified dynamically using a previously determined parameter system are associated to the information request sent to the network 43, e.g. to the Internet. A possible structure for these transformation data is shown in FIGS. 1-3. FIG. 1 shows the structure of the CFIC filter channel 24 (CFIC stands for Custom Filtered Information Channel) associated to the web page 12 and possibly to other web pages. Filter channel CFIC-1 comprises the bookmark 10 pointing to the given web page 12, together with the page filter template 11 (PFT). The PFT 11 describes the structure of the individual web page 12 referred to by the bookmark 10. Structural analysis and description of the web page 12 can be performed in many different ways. For example, HTML tags, physical document layout, type size and colour can be evaluated, and table parameters, text delimiters and keywords appearing in the document, the connecting points (links) in the document can also be taken into consideration.

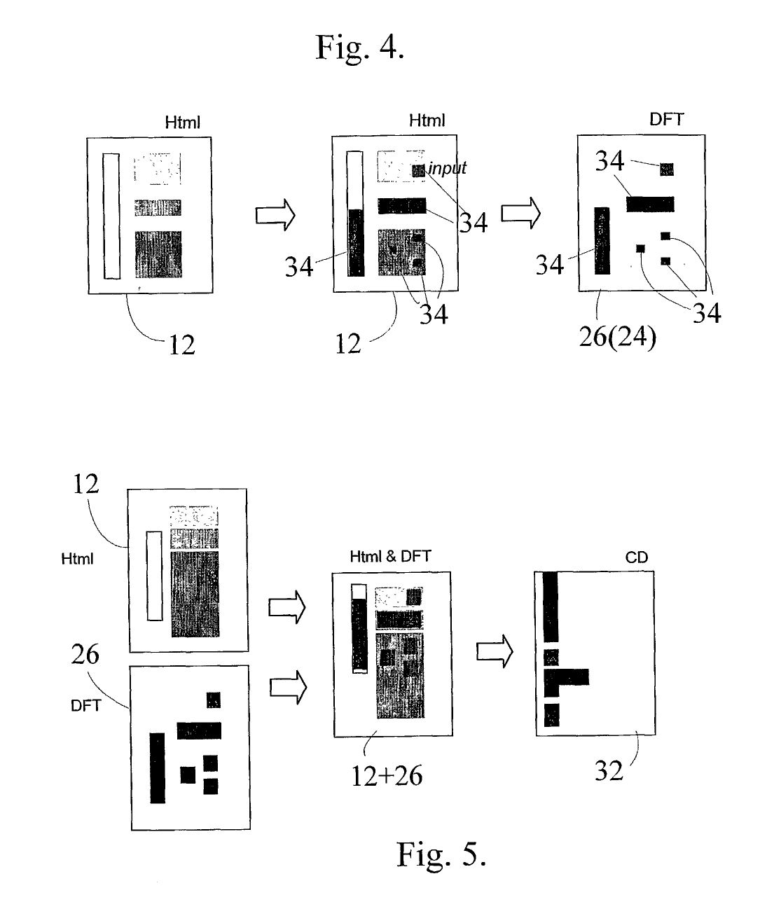

For increased operational flexibility, the PFT 11, being a part of the CFIC 24, can be supplemented by additional parameters 22, which in turn can be static, editable, or dynamic. Static parameters can be set by the user, for instance during the creation of the CFIC 24 (see FIG. 4 as well). Dynamic parameters, which provide information about the time and location of the request as well as personal user data, can be determined by the system itself during individual instances of information request. Alternatively, parameters can be set by the user for each individual request.

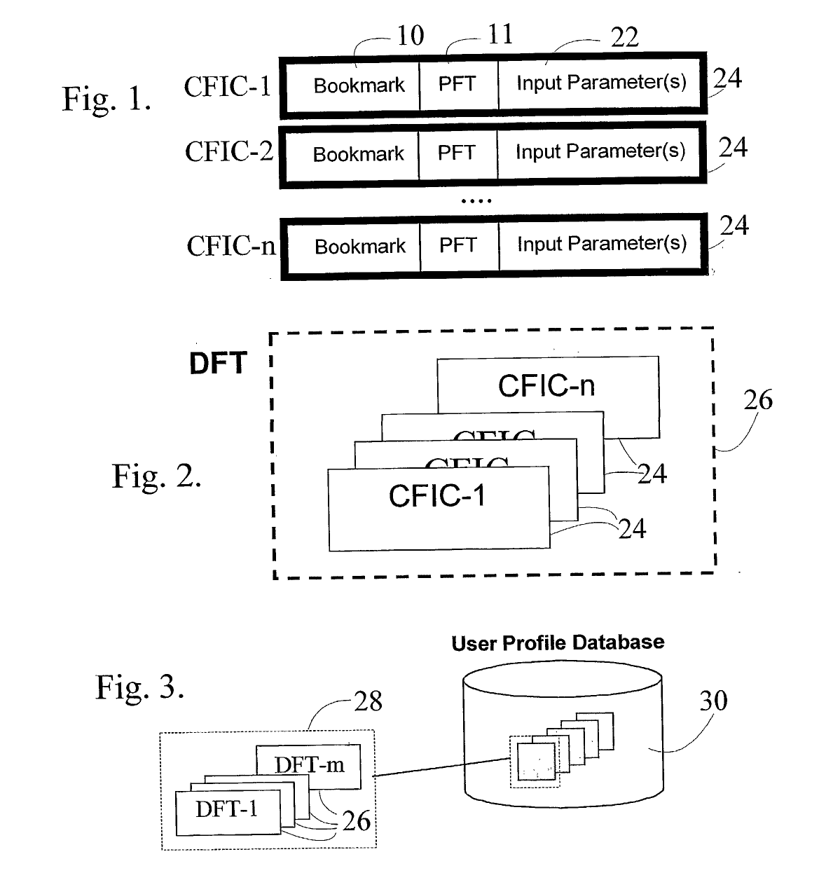

FIG. 2 illustrates the possibility of treating multiple CFIC-1 . . . CFIC-n filter channels 24 together in a document filter template 26 (DFT). This is especially profitable when relevant pieces of information gathered from different web pages have to be displayed at the same time (for instance the user would like to compare currency exchange rates offered by different banks). Finally, as it is shown in FIG. 3, multiple DFT templates 26 associated with an individual user can be assembled in a user profile 28, where these user profiles 28 are stored in a user profile database 30. It is appreciated that in this case transformation data are stored in the CFIC channels 24 and DFT templates 26, and through them the transformation data are contained in user profiles 28 and in the user profile database 30. The information appearing at the user is a customized document 32 (CD), which is generated by applying the DFT template 26 (in some cases containing only a single CFIC channel 24) to a given web page. Because the DFT 26 contains unique transformation data, this way information requested from the data source 16 is transformed using these unique transformation data. These transformation data are unique (individual), because they relate to a specific, well-defined data source. Further, the transformation data allow a transformation according to criteria which was not necessarily contemplated when the data source was compiled. Accordingly, the transformation data are not only unique or individual, but they are also determined by the user receiving the information from the data source, or at least they are determined by a third person on behalf of the user. It is also possible that the transformation or filtering parameters are determined by a third person independent from both the user or the compiler of the data source. In any case, it is this transformed information that is used at the receiving communication means 20, that is, depending on its content, the transformed information is either stored, displayed for the user, or further processed.

FIG. 4 shows the steps of generating the DFT template 26. First the user or any other person defines the CFIC channels 24 by downloading the desired web page 12 as a source document and, by performing structural analysis of the page, determines which segments of the source document are relevant for further use. As a result, all the relevant and needed segments 34 are selected. The document filter template 26 and the CFIC channels 24 contained in the document filter template 26 substantially store the information needed to identify said segments 34. Such information identifying document segments 34 may be, for instance, a reference to a given cell of a given table, a physical location in a web page (displayed on screen), words situated near a given keyword, etc.

For instance, data assigned to the person who receives the information, data corresponding to parameters of the receiving telecommunication means, data gathered from retrieved content, unique data describing data structures of the given information source, or any combination of these data can be considered as unique transformation data. FIG. 4 illustrates the situation when unique data describing data structures of the given information source are considered as the unique transformation data, and thus only those segments 34 of the web page 12 are picked for further use that appear at previously specified locations of the web page 12. The specified locations of the segments 34 is illustrated in FIG. 4 with the physical position of the segments 34, but it must be emphasised that it is only one of many possibilities to perform the filtering according to the physical location of the segments 34. In a given case, the segments 34 may be defined in a number of ways on the whole web page 12, which latter is considered in the method as a unitary data source.

These segments 34 are arranged into a new document by the user, or preferably by a suitable program run on the receiving means 20 or on the server means 14. As it can be seen in FIG. 5, the generated customized document 32 (CD), which might contain the segments 34 of the original web page 12 in a modified order and format, is the final result of the method in this specific implementation. In other words, the customized document 32 (CD) is generated, on the basis of individual requirements specified by the user and stored in the configuring channel 40 (see also FIGS. 6-7). The customized document 32 (CD) may be generated from one source document or, if a more advantageous method is used, from several source documents by filtering, formatting, and editing the documents and, preferably, unifying them.

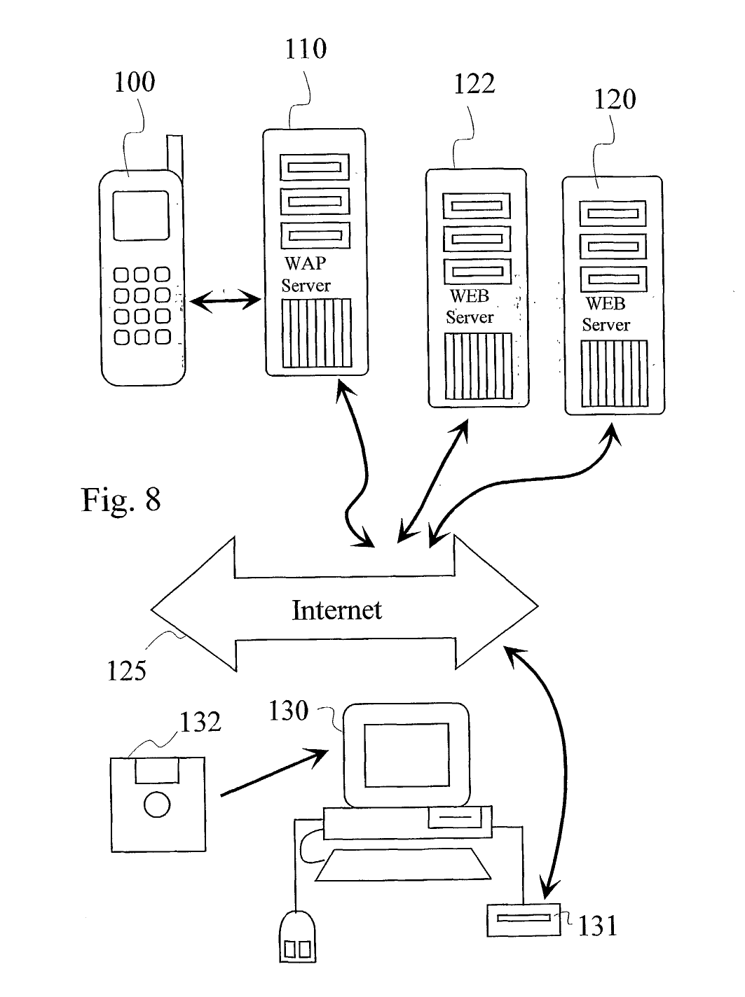

The contents of the customised document 32 is forwarded to the receiving telecommunications means 20 through the receiving communications channel 44. If the receiving communications channel 44 advantageously supports interactive communication, e.g. because it supports WEB or WAP protocols, than links may also be included in the customised document 32 via the document filter template 26 (links may be such connection points as described by the HTML (HyperText Markup Language)—és WML—(Website Meta Language) standards). When such links are used, not only the contents of the customised document 32 are forwarded to the receiving means 20, but also the further documents invoked by the hyperlinks in the original documents or by hyperlinks added during the configuration are sent to the receiving means 20. The effect of the links may be pre-programmed, or they may be activated by the user (typically by using a key or mouse at the receiving means 20, e. g. a computer 130 or a mobile phone 100, see also FIG. 8).

In other cases personal data of the receiving person or transformation data related to the receiving person and previously determined by the receiving person or any other person is considered as the unique transformation data assigned to the person who receives the information. Such data may be the address or e-mail of the receiving person, and the retrieved information may be displayed or not depending on whether the address of the receiving person is found in it or not (e.g. if there are any traffic jams near the street or city where the person lives).

FIGS. 6-7 show two different versions of the system that performs the steps of the method according to the present invention. The main function of the system is to provide access to information stored in a data source 16 managed by a server means 14. The information can be accessed via a telecommunication network, so the server means 14 can also be accessed through a telecommunication network. It has to be emphasised here that the term “telecommunication network” is used in a most general sense, so the telecommunication network can be a computer network, a cable phone or mobile phone network, a PDA (Personal Digital Assistant), UDMA (Ultra Direct Memory Access), or GPRS (General Packet Radio Service) network or any combination of these networks. The system comprises a server means 14, being connected with the requesting telecommunication means 18 and the receiving telecommunication means 20, and optionally with the configuring telecommunication means 36. If the system comprises a separate configuring communication means 36, then the unique transformation data or a part thereof can be specified using this configuring telecommunication means 36. Optionally, a configuring communications channel 40 can be assigned to the configuring telecommunication means 36. A telecommunications channel can be regarded as configuring telecommunications 40 channel if personal data of the user and custom configurations for document request, filtering, formatting, editing, and, optionally merging, i. e. substantially the predetermined transformation data may be specified through the channel.

The server means 14 may comprise a single server or multiple interconnected servers. For instance, the server means 14 can contain a dedicated data source server and a separate WAP or WEB server for providing connections with requesting, receiving, or configuring means or for connecting to other databases or outside networks. If the system contains a separate profile database 30, that is the system performing the method comprises a data storage means storing a database (the profile database 30) that is connected with the server means 14 and contains transformation data, then this data storage means can be handled by a separate DFT server (Distribution Functional Terminal) or a database server managing substantially DFT-type data.

In another implementation a separate data source communications channel 46 is assigned to the data source 16, as it is shown in FIGS. 6-7. In this case the server means 14 connects with the data source 16 through the source communications channel 46. The data source 16 can otherwise be connected directly to the server means 14.

The requesting communications channel 42 connects the requesting means 18 and the server means 14, whereas the receiving communications channel 44 connects the server means 14 and the receiving telecommunication means 20. The configuring communications channel 40 is between the configuring means 36 and the server means 14. Accordingly, the system according to the invention comprises a data source 16 and a server means 14 connected to it, and it further comprises a receiving communications channel 44 and/or a requesting communications channel 42 for facilitating data traffic with the server means. The server means 14 is programmed to perform the server-side steps of the method according to the invention. Accordingly, the server means 14 receives the request sent from the requesting means 18 and, based on the contents of the request, determines the unique transformation data. It might happen that the information request contains at least a part of or even all the transformation data. In that case the server means 14 retrieves the requested information from the data source 16 and usually performs the transformation before forwarding the information towards the receiving means 20 through the receiving channel 44.

In other frequent cases at least a significant portion of the transformation data is stored in a separate database, e.g. the profile database 30, and information requests contain data required for connecting to this separate database, i. e. presently the profile database 30.

Similarly to the embodiments described here, besides the server means 14 the system usually comprises the profile database 30. In these cases both the configuring communications channel 40 and the requesting communications channel 42 can be connected directly to the 30 profile database, so information requests are sent to the server means 14 through an additional communications channel 48 connecting the server means 14 and the profile database 30. The additional communications channel 48 provides for bi-directional data traffic in order to facilitate the transmission of both requests coming from the server means 14 and the traffic in the direction of the server, containing the transformation data.

If at least a portion of the transformation data is stored by the profile database 30, then the server means 14, based on an information request containing such information, retrieves transformation data partly from the database 30 besides using the data source 16, and either performs the transformation itself, or forwards the retrieved information together with transformation data towards the receiving means 20.

In case the request coming from the requesting means 18 contains all the needed unique transformation data, the profile database 30 can be omitted.

It is in principle possible to choose the requesting communications channel 42, and/or the receiving communications channel 44 and/or the configuring communications channel 40 to be identical with or to be different from one another, in any combination. In the example shown in FIG. 6, the communications channels are chosen to be different from one another. For instance, configuration is performed through an Internet connection, while information is requested via a mobile phone network and received by a fax machine connected e.g. to a cable phone line. In these cases the requesting means 18, the receiving means 20, and the configuring means 36 are usually also different from one another.

In the system shown in FIG. 7 the requesting communications channel 42, the receiving communications channel 44, and the configuring communications channel 40 are implemented as a single common communications channel 45. Accordingly, the requesting means 18, the receiving means 20, and optionally the configuration means 36 are embodied as a single telecommunication means 47, e.g. a network computer, while the common communications channel 45 can in practice be an ISDN connection.

Otherwise, a computer, a mobile phone, a cable phone, a PDA device and/or pager may be applied as the requesting means 18 and/or receiving means 20 and/or configuring means 36, mentioning these particular devices only as non-limiting examples.

The data determining the transformation of information sent from the data source 16 to the receiving means 20 can be of many types. In the most typical case, data determining the filtering and/or editing and/or supplementing and/or displaying of the retrieved information are regarded as transformation data.

In most cases the data source 16 stores a source document, e.g. a web page 12. Any information requested and retrieved from a given data source 16 using the source communications channel can in a general sense be regarded as such a source document (or source page). The result of the information request depends on transformation data previously assigned to the individual query, or on input data provided by the user and/or on current (dynamically assigned) input data related to the user. By querying multiple data sources, multiple source documents are generated. Though the source document usually includes all the information demanded by the user, it frequently has more information content than desired, and further the format of the document is often significantly different from that demanded by the user. The method according to the present invention solves, among others, this problem.

In a number of cases, for instance, information filtering amounts to the filtering of this source document by means of any known filtering method that allows the searching for a specific content in a larger document, according to given search criteria, and thereby removes the superfluous contents of the document. Examples of filtering can be searching for a given word, or for content located near a given word, that is, in the same paragraph, text line or table row as the search word is located; or searching for content at a given location in a document such as e.g. below an image, in the header of a given table, etc. The reformatting of such a source document may also be regarded as the editing the retrieved information. Reformatting or editing the source document is preferable because the customized document generated from the source document are frequently transmitted on a different type of communications channel than the one used for transmitting the source document. Therefore, generally their format determining the physical appearance of the document is significantly different, and often this difference is a necessity. The unique customized document is also usually more condensed than the original document, because the customized document was generated by a filtering process. Therefore, it has often a format and physical appearance inevitably different from the original source document.

As an example of this format change, it is preferable to display data retrieved from a row of a table simply in a single text line instead of retaining the table format.

Another example can be the conversion from WEB to WAP, where, due to the limited length of a text line, it is useful to break the line after a recurring long word. Beside the compression, advantageously a part of the links or even all links may be retained as well, because both the WEB and WAP protocols are interactive.

It may be regarded as an editing of the information, i. e. the source document, when the user determines the custom filter and format settings, and the user also supplements selected parts of the source document by adding new content to it, or, alternatively, the user may also choose to display certain selected contents in a modified format. For example, it is possible to multiply a retrieved numeric value by a constant (e.g. by a currency exchange rate) and display only the multiplied value. Or, the user can display a maximum temperature value, retrieved from a table, preceded by the word “Hottest”.

Transformation data may be data which determines how the retrieved information should be unified with other pieces of information. Typically this is the case when multiple source documents are united or merged. In this case the user's customized document is generated by merging multiple filtered, formatted, and edited source documents into a single document. Every morning, for instance, the user can receive the maximum daily temperature forecast and a selected exchange rate value together in a single SMS message.

In an important case, the change of the retrieved information with respect to its previous state is regarded as transformation data. In order to be able to perform comparisons, the system has to store the previous state of the information independent of original source of the information, e.g. in the filtering channel 24 assigned to the given source document, or in a dedicated part of the profile database 30.

In another implementation, data for the identification of the requesting person are regarded as transformation data. Identification data can for instance be, among others, the name of the requesting person. In practice, however, it is mostly through the user's telecommunication identifier that such data can be obtained, for example by finding the person by means of a phone number transmitted by the GMS protocol.

An example of user identification is the case of a mobile phone user asking through WAP the departure times of the next trains to “home”, that is, to the town where the user lives. As an answer, the user receives an SMS including the station of departure and departure times. In this case, the user's address, either obtained dynamically from a database or previously stored as personal data, is transmitted as input data. The user's current physical location can be established with an accuracy of 300 meters using cell and location information provided by WAP communication. Also, there are travel service websites providing railway timetable information (e.g. at the URL http://elvira.mavinformatika.hu), where both the station of departure and the destination can be specified, together with preferred times of the day. The answer for such a timetable query is usually sent as an HTML document, which frequently contains too much data to be transmitted to a WAP mobile phone. Therefore, in order to render the information receivable with the limited-capacity receiving means, the HTML document has to be filtered, reformatted and optionally supplemented by a short “Next train home:” message line, thereby composing a concise SMS message.

Another example can be a user ordering a taxi in a foreign city using his WAP-enabled mobile phone by visiting his own WAP page and selecting the “Taxi order” menu item. The WAP server can in principle be located where the user usually lives, or at any other suitable location, but the WAP communications channel provides information about the user's current physical location as dynamic input data. Using a suitable database, a local taxi company can be found and sent an SMS message containing the user's name and phone number (these data have been stored previously). The WAP protocol specifies the user's current location, and then the reply message sent by the taxi company is forwarded by the system to the user's mobile phone in the form of an SMS message that contains the company's name and the approximate time when the taxi arrives. Compared with the above example, this scenario illustrates an additional advantageous feature of the inventive method: namely that the method is used in a transaction for concluding a passenger transport agreement, or at least for the making of an offer to conclude such an agreement, where the concluding of said passenger transport agreement is based on a unique transformation of specific data. Thus, in this case, access of information according to the inventive method is applied for a transaction for concluding an agreement, the concluding of the agreement being based on data exchange.

It may also be regarded as transformation data when individual hypertext links are inserted in the customised document, where the links point to other customised documents. In this manner it is possible to generate a series of customised documents, or a hierarchical graph of customised documents, or chained customised documents. If the link points to another source document, its content may also be forwarded to the receiving channel by the complete conversion described above.

In this case it is possible that the chain of customised documents contains a data source which itself is not filtered or transformed. This unfiltered document may be in any part of the chain.

As a particular form of transformation, we mention the complete mapping, where the information content of the source document is preserved to the maximum possible extent. In such a transformation, only those formatting differences are surmouted which are due to the difference between the source communication channel and the receiving communications channel. It is to be noted that this transformation do not need any separate configuring step, because the transformation only depends on the general properties of the communications channels, which are known beforehand, and the transformation itself does not depend on the information content. However, it is still possible that a single source document is mapped as multiple interconnected documents.

This latter transformation without hypertext links and content filtering, i. e. where only format transformation is peformed, is shown with the following example:

When a filtering from WEB to WAP is made from a web portal collecting multiple news categories, only the hypertext links pointing to the different news categories are preserved from the start page, and all other information is removed. The contents of the pages of the different news categories (as sport, domestic politics, etc). are preserved to the maximum extent allowed by the possibilities of the WAP, e.g. only high resolution images illustrating the contents are removed. In this manner, the web pages of the various news categories do not require individual detailed configuration. However, the contents of even a single WEB page fits typically into multiple WAP pages only, which WAP pages may be interconnected through hyperlinks, either hierarchically or on an equal level. Concerning their content, the WAP pages are practically the continuation of the previous page.

Transformation data can as well be data identifying a person different from the user, for example when the user makes a query for the phone number of a contact using a WAP-enabled mobile phone. In this case the user's profile contains a reference to a phone directory service website. To perform the query the user starts the WAP micro-browser, types in the name of the contact, and in a few seconds receives the desired phone number on the display.

In another implementation, authentication data are sent to the server means and/or to the data source during a further step of the method. Authentication data are typically passwords or tokens.

Transformation of the information according to the transformation data is usually performed at least partly with the server means 14 and/or the receiving telecommunication means 20, as it is depicted particularly in FIG. 7. However, it is also possible that the transformation of the information according to the transformation data is performed at least partly with a transformation means 50 in the receiving communications channel 44 between the server means 14 and the receiving telecommunication means 20. The transformation means 50 can be a dedicated computer or any other suitable hardware means capable of transforming the retrieved information according to the transformation data. In this case, in principle the transformation data can be transmitted to the transformation means 50 through an additional separate communications channel 44′ instead of said transformation data being transmitted through the receiving communications channel 44. The separate communications channel 44′ establishes a direct connection between the profile database 30 and the transformation means 50, where the communications channel 44′ can be of any known type, similarly to the requesting and receiving communications channels.

If transformation of the information according to the transformation data is performed at least partly with the receiving communication means 20, a separate communications channel 44″ can be also added, where this communications channel 44″ establishes a direct connection between the profile database 30 and the receiving telecommunication means 20.

An object of the invention is a computer program product comprising commands to execute the server-side steps of the inventive method. Such a computer program is substantially an application running on the server means 14, and provides for performing functions of the server means 14 and of the profile database 30 as described above. Another object of the invention is a computer program product comprising commands to execute the user means-side steps of the inventive method. Because the requesting means 18, the receiving means 20, and the configuring means 36 are in certain cases implemented as separate machines, the program performing user functions and operating said machines can consist of separate individual programs.

Further examples for the application of the method according to the present invention is illustrated with reference to FIG. 8.

As an example, the user wishes to find out the current weather in a certain location. For this purpose, the user visits his own unique web page with a web browser running on a computer 130 connected to the Internet 125, where the Internet 125 represents the network 30. The connection is done in a known manner, e. g. using the modem 131. The unique web page of the user may be stored on the WEB server 120, which may coincide with the computer 130 of the user. On his unique web page the user selects the “weather” field that has previously been defined in the configuring channel. A DFT template is assigned to the selected field, with the template containing transformation data referring to a web page with a fixed URL, which contains weather data for the given location. E.g. the weather forecast for Budapest can be found at the web page identified by the URL http://www.weather.com/weather/cities/hu_budapest.html. This web page may be stored on the web server 122. Under the command of the filter template, the device performing the transformation, presently the computer 130 which also acts as the receiving means, accesses the desired web page through the Internet 125, and searches for the “Temp” field (referring to temperature). Thereafter the transforming device retrieves the temperature value from the “Temp” field of the table, removing table format tags in the meanwhile. The retrieved temperature value, e.g. 59° F. is now displayed, with a previously determined expression (for example, “Temperature today:”) displayed above it. This way a new customized document has been created, which may be stored physically either in the memory of the computer 130, or the web server 120, or even of the WAP server 110, either in a transient or permanent storage means (this latter are not shown separately). The final filtered and transformed information can be displayed with the user's WAP-enabled mobile phone, as an example. Alternatively, the information can be sent to the user's conventional GSM mobile phone 100 as an SMS message, if the mobile phone 100 is not WAP compatible. The transformation of the data may be done on the WAP server 110, or on the web server 120 storing the individual web page of the user. The appropriate program, i. e. the software performing the method runs on the WAP server 110 or the web server 120. FIG. 8 do not shows separately the known GSM network creating the physical connection between the WAP server 110 and the mobile phone 100.

Alternatively, the customized document can also be sent to the web browser of the user's computer 130 as a dynamically generated web page.

The computer program product performing the method, i. e. performing the transformation runs on the computer 130, optionally loaded from an external data carrier 132.

Using a similar application it is possible to answer a more general question, if, for example the user would like to know if it is cloudy in a given city. Apart from exact temperature and pressure values web pages containing weather information usually contain a general term that describes weather conditions. The task is to decide on the basis of this general term if the sky is cloudy or not. Fixed formal definitions are inadequate for finding variable-position information. Thus, in these cases the desired information can only be retrieved using known artificial intelligence procedures. For instance, it can be useful to search for lines that contain given words, e.g. “sky”, “cloudy”, “sunny”, “clear”, etc. The right answer might be the sentence in that line, even if this sentence is not in its usual position. Tables are even more difficult to process. The extraction of the information may be performed with multiple parallel running algorithms, and the most probable end result may be selected taking into account the efficiency of individual algorithms and the similarities and differences among their results.

2. Retrieving the Contents of a Permanent Column From a Newspaper's Website

These pages are usually password-protected and can be accessed only through an authentication page, where the user's registration data must be specified. After successful authentication the page corresponding to the desired column can be opened. The method according to the invention automates the authentication procedure by filling in forms in the name of the user with the user's registration data. That way it is possible for the user to send a request from his own communications means identified with the phone number and/or MSISDN (Mobile Station International ISDN Number) identifier and/or IMEI (International Mobile station Equipment Identity) number thereof by starting a specific request stored among his own profiles, and to receive and display the desired document.

3. Web-based Interactive Request Profiles

By using a special web page, the user can specify in advance details of requests he would like to make at a future time when he will only have a limited-capacity receiving means, e.g. a mobile phone for making the prospective request, and no web browser will be available. On this special page the user can choose the web page he would like to filter, and he can specify the content he wants to receive together, the communications channel for receiving the filtered content, and optionally he may decide to combine specific contents from multiple web pages into a single customized document. For this procedure, the user may advantageously use previously selected documents such as weather forecasts, news or combinations thereof.

The present invention is not limited to the shown embodiments, but encompasses all combinations and variations of the shown features, and the scope of the invention is determined by the following claims only.

1. Method for accessing information from a network data source, the network data source being managed by a server means, wherein
an information request is sent through the network to the server means from a requesting telecommunication means, and
information is retrieved from the data source with the server means, and the information retrieved from the data source is forwarded to a receiving telecommunication means, and further the information used at the receiving telecommunication means is transformed,
characterised in
a, associating dynamically determined unique transformation data to the information request, the transformation data being determined based upon a predetermined and/or previously fixed parameter system, and
b, transforming the requested information based on the unique transformation data, and
c, using at the receiving telecommunication means the information transformed according to the unique transformation data.

2. The method of claim 1, in which
a, unique data associated to the person receiving the information and/or
b, unique data associated to the parameters of the requesting and/or receiving telecommunication means and/or
c, unique data extracted from the contents of the requested information and/or
d, unique data relating to the data structure of the data source are regarded as the unique transformation data.

3. The method of claim 1 or 2, in which personal data of the receiving person or data relating to the receiving person are regarded as the unique data associated to the person receiving the information, where the data relating to the receiving person is previously determined by the receiving person or by an other person.

4. The method of any one of claims 1 to 3, in which the telecommunications network is a computer network, cable- or mobile phone network, PDA-, UDMA- or GPRS network or a combination thereof.

5. The method of any one of claims 1 to 4, in which a requesting communications channel is associated to the requesting telecommunication means and/or a receiving communications channel is associated to the receiving telecommunication means.

6. The method of any one of claims 1 to 5, in which the unique transformation data is set with a configuring telecommunication means, and optionally a configuring communications channel is associated to the configuring telecommunication means.

7. The method of any one of claims 1 to 6, in which a data source communications channel is associated to the data source.

8. The method of any one of claims 1 to 6, in which the requesting communications channel and/or the receiving communications channel and/or the configuring communications channel is selected to be the same or selected to be different from each other.

9. The method of any one of claims 1 to 8, in which the accessing to the information is used in a transaction for concluding an agreement, the concluding of the agreement being based on data exchange.

10. The method of any one of claims 1 to 9, in which at least a part of the transformation data is included in the information request.

11. The method of any one of claims 1 to 10, in which at least a part of the transformation data is contained in a separate database, and the information request contains data for connecting to the database.

12. The method of any one of claims 1 to 11, in which data determining the filtering and/or editing and/or supplementing and/or displaying of the information is regarded as transformation data.

13. The method of any one of claims 1 to 12, in which a change of the information with respect to its previous state is regarded as transformation data.

14. The method of any one of claims 1 to 13, in which data for determining the unification of the information with other information is regarded as transformation data.

15. The method of any one of claims 1 to 14, in which data for the identification of the requesting person is regarded as transformation data.

16. The method of any one of claims 1 to 15, in which identification data are forwarded to the server means and/or to the data source in connection with the information request.

17. The method of any one of claims 1 to 16, in which the transformation of the information according to the transformation data is performed at least partly with the server means and/or with the receiving telecommunication means.

18. The method of any one of claims 1 to 17, in which in which the transformation of the information according to the transformation data is performed at least partly with a transformation means in the receiving communications channel between the server means and the receiving telecommunication means.

19. The method of any one of claims 1 to 17, in which a computer and/or cable phone and/or mobile phone and/or PDA device and/or pager is used as the requesting and/or receiving and/or configuring telecommunication means.

20. A system for accessing information from a network data source, the network data source being managed by a server means, the system comprising a data source and a server means connected to the data source, and further comprising a receiving means and receiving communications channel and/or requesting communication channel for facilitating data traffic with the server means, characterized in that the server means and the receiving means is programmed to perform in co-operation with each other the steps of the method of any one of the claims 1 to 14.

21. The system of claim 20, further comprising a data source communications channel between the server means and the data source.

22. The system of claim 20 or 21, further comprising data storage means storing transformation data, the data storage means being connected to the server means.

23. The system of any one of claims 20 to 22, further comprising a configuration channel, the configuration channel being connected to the server means and/or to the data source.

24. The system of any one of claims 20 to 23, comprising a single server or multiple interconnected servers.

25. The system of any one of claims 20 to 24, in which the server means comprises a data source server and/or WAP-server and/or WEB-server and/or database server and/or DFT database server.

26. A computer program product comprising commands to execute the server-side steps of the method of any one of claims 1 to 19.

27. A computer program product comprising commands to execute the user-means-side steps of the method of any one of claims 1 to 19.

28. The system of any one of claims 20 to 25, in which the telecommunications network is a computer network, cable- or mobile phone network, PDA-, UDMA- or GPRS network or a combination thereof.

29. User means for accessing a server means through a telecommunications network, comprising a computer program product having commands to execute the user-means-side steps of the method of any one of claims 1 to 19.

30. Server means for data communication with a user means through a telecommunications network, comprising a computer program product having commands to execute the server-side steps of the method of any one of claims 1 to 19.
